(19) United States
(12) Patent Application Publication
(10) Pub. No.: US 2006/0141204 A1
(43) Pub. Date: Jun. 29, 2006

(54) Packaging of organic light-emitting diodes using reactive polyurethane

(75) Inventors: Wolfgang Rogler, Mohrendorf (DE); Wolfgang Roth, Utttenreuth (DE)

Correspondence Address: YOUNG & THOMPSON, 745 SOUTH 23RD STREET, 2ND FLOOR, ARLINGTON, VA, 22202, US

(73) Assignee: Siemens Aktiengesellschaft, Munchen (DE)

(21) Appl. No.: 10/545,162

(22) PCT Filed: Feb. 17, 2004
(86) PCT No.: PCT/EP04/01497

§ 371 Date: Aug. 11, 2005

(30) Foreign Application Priority Data
Feb. 18, 2003 (DE) 103 06 811.2

(51) Int. Cl. B32B 3/02

(52) U.S. Cl. 428/69; 428/68

(57) ABSTRACT

The invention relates to an organic light-emitting diode containing polyurethane with free isocyanate groups for binding any undesirable atmospheric moisture that penetrates the packaging of the diode.

The invention relates to the packaging or organic, light-emitting diodes or displays, specifically to the protection of the diodes or displays against atmospheric effects, especially oxygen and water or water vapor.

The Fabrication of Organic, Light-Emitting Diodes (OLEDs), the processes and materials used are described in detail in the literature. The reader is referred here to the “Philips Journal of Research”, 1998, Volume 51, No. 4, pages 467 to 477.

To guarantee a sufficient lifetime of the OLED a hermetic encapsulation is needed, since materials used for the OLED, especially cathode materials with lower exit work, for example Calcium, but also polymers, react with oxygen and water. As a result of this degradation phenomena occur which reduce the lifetime of the OLED and thus prevent commercial use of the corresponding modules.

A glass cap represents an effective protection from environmental influences, said cap being able to be glued on for example by means of a light-cured epoxy adhesive. Selection of suitable adhesives allows so-called 85/85 test criteria, meaning storage at a relative humidity of 85% and of a temperature of 85° C. to be met over a period of time which is sufficient for many applications, for example in mobile telephones. For other applications, for example in the automotive area however, higher demands are made.

Different measures are known for improving product lifetimes. U.S. Pat. No. 5,821,692 describes the use of perfluorinated fluids within the cap cavity. U.S. Pat. No. 5,734,225 discloses the use of water-repelling silicon layers in combination with yet further inorganic layers EP 0 884 930 A1 discloses the use of water-absorbing polymers, for example polyimide, polyvinyl alcohol and polybutyral, likewise in combination with further inorganic layers. The use of inorganic materials, for example zeolite-based getter tablets within the cap cavity, is known from U.S. Pat. No. 5,882,761. All these materials react reversibly with water, which means that the water can be given off again, especially at a higher temperature and can damage the OLED.

Using this as its starting point, the object of the invention is to improve the protection of encapsulated components against effects from the atmosphere, especially oxygen and water or water vapor.

This object is achieved by the inventions specified in the independent claims. Advantageous embodiments are produced by the dependent claims.

For protection against the effects of the atmosphere, especially oxygen and water vapor, an organic material is used which reacts irreversibly with water. In principle hygroscopic materials, that is those which react with water from the air, are suitable for this purpose. Suitable materials should in addition be inert in relation to the materials used to fabricate the OLED. This also applies to the reaction products of the materials with water.

The module to be protected is especially a package encapsulating one or more organic components. It features a capsule to protect the components from environmental influences, especially from moisture. The capsule can be present in the form of any given container for the component, especially a sealed container. To bind in humidity which penetrates into the capsule or is already present in it an organic material which reacts irreversibly with water is disposed in the capsule.

From the plurality of possible materials available, those with free Isocyanate groups have been shown to be particularly effective. These free Isocyanate groups can react with the undesired water.

Free isocyanate groups can be made available at low cost through the use of hygroscopic, water-reactive polyurethane, which contains residual free isocyanate groups. The polyurethanes can then be perceived to a certain degree as prepolymers which react irreversibly under the effect or water, for example through cross-linking.

The material is preferably disposed in a cavity of the capsule and should fill this cavity either completely or almost completely.

The capsule can for example be formed from a substrate and a cap into which a cavity is made.

If the capsule is to be transparent glass can be used as the material for the substrate and/or the cap. Alternatively caps made of metal or ceramic can also be used.

The organic component is preferably an electro-luminescing component, especially a light-emitting diode.

The component can be arranged on the substrate and covered by the cap.

With a method for encapsulation of components, especially organic components, material which reacts irreversibly with water is disposed in a capsule which contains at least one of the components. This material preferably features free isocyanate groups and is furthermore preferably polyurethane.

The material can be applied locally by dosing, especially dispensing.

As an alternative or in addition the material can be applied to the surface by screen printing.

Further significant advantages and features of the invention are produced from the description of exemplary embodiments. The Figures show:

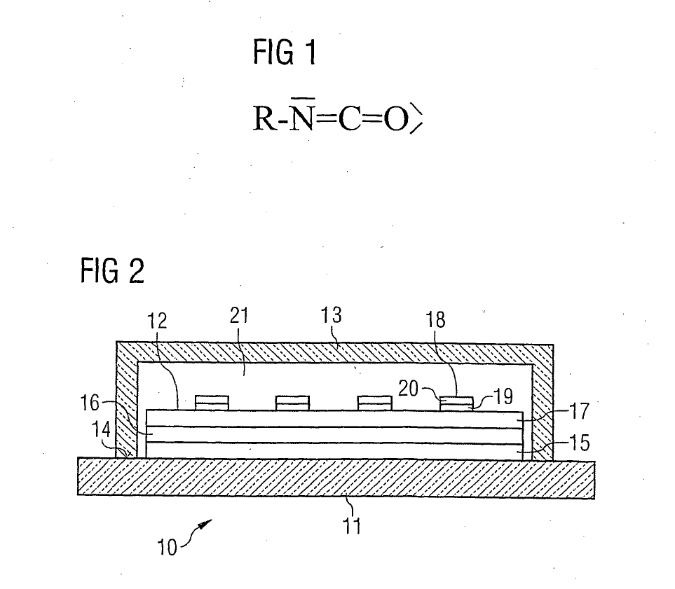

FIG. 1 a free isocyanate group;

FIG. 2 a module in the form of a package encapsulating an organic component.

The isocyanate group shown in FIG. 1 is very reactive and reacts under relatively mild reaction conditions and with compounds which carry acids or active protons, for example water.

Plastics which are formed through polyaddition of multi-functional isocyanates and compounds (alcohols) carrying at least two hydroxyl groups are referred to as polyurethane.

Suitable polyurethanes in accordance with the invention are those with a relevant residue of free isocyanate groups, that is those which are known as moisture-curing single-component systems. These are used as adhesives and sealants in industry, for example in the field of glass gluing. They are produced from diisocyanates and dioles, in which case it is necessary to ensure that a residue of free isocyanate groups is left. These groups react irreversibly with water, in which case carbamine acids are formed which in their turm form with hydrolysis of carbon dioxide amines These in their turn react with free isocyanate groups of other molecules forming substituted carbamides. Thus a water-initiated cross-linking between polymer chains occurs.

The production of oligomers and prepolymers based on polyurethane occurs through the reaction of diisocyanates and dioles. Some of the most widely-used basic components are listed below. On the diisocyanate side these are for example toluoldiisocyanate, diphenyl methane diisocyanate, hexamethylene diisocyanate, xyloldiisocyanate and isophoron diisocyanate. On the polyole or polyhydroxy compounds side, hydroxyterminated polyethers, polyesters, polyolefines and glycols should be mentioned. The production of polyurethane and the reactions of the isocyanate group with water amines are described in the literature.

As stated, the polyurethanes mentioned are widely used as glues or sealants. For inventive use of the reactive polyurethane however not only the adhesive or sealant effect is decisive but the ability of the free isocyanate groups still present in these polymers to react with water. The use of the reactive polyurethanes claimed for the OLED relates to the irreversible chemical reaction of the isocyanate groups with water. The reactive polyurethane is thus used as an irreversible organic water getter. The reactive polyurethanes used can be filled with fillers known from the area of adhesives and sealants.

For processing reasons the polyurethanes which are especially suitable are those which have a paste-like consistency. They can then be applied for example by means of dispensing or screen printing. Advantageously the quantity of the dose is such that after the assembly of the joints of a capsule, the dosed material fills out the volume of the cavity of the capsule to be filled completely or almost completely. The reactive polyurehane and the adhesive used for gluing-on the cap of the capsule can both be located on the same joint section, but also separately one on each of the joint sections.

A decisive requirement for using the polyurethanes is their inertness with regard to the materials normally used for fabricating an OLED. This applies especially to the metals which are as a rule used for the cathode with low exit work, for example calcium. Although groups are extremely reactive they are only react in the proposed application as intended with water which is penetrating but not with calcium or other materials used in the fabrication of the OLED. In addition, as a result of the formation of carbon dioxide, no overpressure damaging the OLED occurs. This also applies to the OLED packaging, meaning of the gluing of the OLED with a glass cap. Surprisingly there is OLED compatibility in the case of the reactive polyurethane.

FIG. 2 shows of a cross-section through a component 10. In this case an OLED 12 is arranged on a glass substrate 11. The OLED 12 is covered by a glass cap, the edge 14 of which is glued to the glass substrate 11. Glass cap 13 and glass substrate 11 form one capsule. The OLED 12 features the following components: A transparent electrode 15, made of ITO (indium-tin-oxide) for example, an organic hole transport material 16, for example made of a conductive polymer, an organic electroluminescing material 17, for example a light-emitting polymer, and a metal electrode 18, which is made up of calcium 19 and silver 20 for example. The organic electroluminescing material 17, which means the emitter (chromophore), serves in this case simultaneously as the electron transport material. The two functions can however also be separate, in which case the electron transport material is then arranged between metal electrode and emitter. Above the component arranged on a glass substrate 11 in the form of the OLED 12 is the cavity of the cap 13 filled with a material 21 which reacts irreversibly with water. This material 21 is preferably polyurethane with residual free isocyanate groups.

The fabrication of the component in the form of an organic light-emitting diode is undertaken for example by spin coating if polymer solutions are processed or by vapor deposition if monomers are used. ITO (indium-tin-oxide) coated glasses are used as a substrate in which case the ITO can also be structured. ITO is transparent and is used as a anode because of its electrical properties. If necessary help layers such as hole- and electron-conducting layers are used. Metals with small exit work such as for example calcium are applied by vapor deposition as cathodes. The diode with the class cover is packaged and also the material which reacts irreversibly with water in the form of a water-absorbing layer is applied in an inert atmosphere, which means in particular in an atmosphere free of water and oxygen.

The details of the fabrication of light-emitting diode on the basis of polymers are as follows. In this case, to aid clarity, the fabrication of a diode without material which reacts irreversibly with water is initially described.

Two parallel 2 mm-wide ITO strips at a spacing of 1 cm are created on an ITO-coated glass substrate with 5×5 cm edge length and of a thickness of 1.1 mm by means of photolithography. Exposed locations are not removed in an alkaline area. This protects the ITO. Revealed ITO is removed with concentrated HBr at a temperature of 40° C. for two minutes. A 70 nm thick layer of PEDOT (polyethylene dioxothiophenone) is applied to the ITO-structure glass wafer for example by means of spin coating from an aqueous solution. This layer is dried in a tempering process of 200° C. for five minutes. Subsequently the xylol emitter layer is applied at a thickness of 100 nm, for example also by spin coating. This layer is dried at a reduced pressure of 10⁻⁶ mbar. Similarly at this pressure two 2 mm-wide calcium strips are applied by vapor deposition as a cathode at a distance of 1 cm using a shadow mask. These metal strips are arranged at right angles to the ITO-S structures located on the glass substrate.

The surfaces of the crossing anodes and cathode tracks, between which the polymers are located, represent the active surface of the light-emitting diode. Silver strips to a thickness of 150 nm are applied by vapor deposition to the calcium strips. No metal is deposited on the adhesive locations for example. The organic layers are removed manually from these locations. This can for example be done with a blade.

The polymer-free area can also be created as described in 03/03481 A2. Subsequently the four diodes obtained in this way are encapsulated with a glass cap. The method and devices described in 01/18886 A2 and 01/18887 A1 can be used in particular to do this. The external dimensions of the cap are 24×24 mm in the exemplary embodiment, the adhesive edge is 1 mm and the depth of the cavity 200 μm.

The parts to be joined are positioned in relation to each other in an inert, which means especially a water- and oxygen-free atmosphere, and for example glued to each other with an organic adhesive.

If a voltage of for example is applied to the ITO electrode (anode) and the Ca electrode (cathode) the encapsulated diode lights. The lifetime obtained with such a diode when stored at a temperature of 85° C. and of a relative humidity of 85% is for example 120 hours and serves as a reference for the lifetimes stated below.

To increase the lifetime a material which reacts irreversibly with water is used in the fabrication of the light-emitting diodes. Reactive polyurethane is especially used for this purpose. The material is dosed by means of a dispenser centrally to the inside of the glass cap cavity. The quantity is selected so that when the glass cap is put on and pressed down the volume of the cavity is completely or almost completely filled, whereby the organic component is completely covered with a water-absorbing organic layer based on polyurethane. The glass cap is glued on after positioning by means of a light-cured epoxy adhesive. The amount of glue needed for this is applied to the organic component by means of a dispenser.

When stored at a temperature of 85° C. and a relative humidity of 85° the lifetime of an OLED fabricated in this way is improved by the use of the reactive polyurethane by the factor of 3.

As an alternative or in addition the material which reacts irreversibly with water can also be applied in the form of the reactive polyurethane by means of a dispenser centrally to the organic component. When the glass cap is put on, the material is distributed so that the volume of the cavity is completely or almost completely filled up. The glass cap is glued on after positioning by means of a light-cured epoxy adhesive. The adhesive bead needed for this is applied to the organic component by means of a dispenser. In this case too the lifetime of a OLED at a temperature of 85° C. and a relative humidity of 85% is improved by a factor of 3 by the use of reactive polyurethane.

1. Module with a capsule containing a component, especially an organic component, characterized in that a material which reacts irreversibly with water is disposed in the capsule to protect the component from water.

2. Module in accordance with claim 1, characterized in that the material features free isocyanate groups.

3. Module in accordance with claim 2, characterized in that the material features polyurethane structures.

4. Module in accordance with claim 1, characterized in that the material is arranged in a cavity of the capsule.

5. Module in accordance with claim 4, characterized in that the material completely or almost completely fills the cavity.

6. Module in accordance with claim 1, characterized in that the capsule features a substrate and a cap.

7. Module in accordance with claim 6, characterized in that the cap features a cavity.

8. Module in accordance with claim 1, characterized in that, the capsule is at least partly transparent.

9. Module in accordance with claim 1, characterized in that the component is an electroluminescing component, especially a light-emitting diode.

10. Module in accordance with claim 1, characterized in that the component is fabricated from organic semiconductors.

11. Module in accordance with claim 1, characterized in that the component is arranged on a substrate, especially a flexible substrate.

12. Method for encapsulating a component, especially an organic component, in which a material which reacts irreversibly with water is disposed in a capsule to protect the component from water.

13. Method according to claim 12, in which the material is applied locally by dosing, especially by dispensing.

14. Method according to claim 12, in which the material is applied to the surface by screen printing.
